(19) United States
(12) Patent Application Publication
(10) Pub. No.: US 2017/0024810 A1
(43) Pub. Date: Jan. 26, 2017

(54) AUCTION SERVER AND SELLING METHOD THEREOF

(71) Applicant: Ying-Tsun SU, Taipei (TW)

(72) Inventor: Ying-Tsun SU, Taipei (TW)

(21) Appl. No.: 14/805,245

(22) Filed: Jul. 21, 2015

(51) Int. Cl. G06Q 30/08

(52) U.S. Cl. CPC G06Q 30/08

(57) ABSTRACT

An auction server and a selling method are provided. The auction server creates an auction with a bidding period for bidding a limited service during a non-repeatable period, time, and date. Further, after receiving a plurality of bid requests which include buyer IDs and bid prices thereof for the auction from a network, the auction server is able to determine at least one winning buyer ID from the buyer IDs according to a quantity of the limited service and the bid prices of the buyer IDs when the bidding period is expired. Accordingly, the auction server generates an auction result that indicates the at least one winning buyer ID and the bid price thereof.

### CROSS-REFERENCES TO RELATED APPLICATIONS

Not applicable.

### BACKGROUND OF THE INVENTION

Field of the Invention

The present invention relates to an auction server and a selling method thereof. More particularly, the auction server of the present invention allows a service-provider to create an auction with a bidding period for bidding a limited service during a non-repeatable period, time, and date.

Descriptions of the Related Art

In recent years, more and more people like to take part in different activities during a special period for entertainment. For example, millions of people may crowd into the Time Square in New York on the New Year's Eve. This situation creates the opportunity for scalpers to book a large number of hotel rooms located near the Time Square first when the New Year's Eve is approaching, and then resell the hotel room to others at a higher price.

In another scenario, a large number of sport game entrance tickets may be sold out right away by the scalpers when the sport game is in a quarter-final, a semi-final or a final. Under the circumstances, people who is actually interested in the sport game may have to buy the ticket at a much higher price from scalpers. It can be seen that scalpers can get the specific service (e.g., hotel rooms nearby a popular landmark during a special period, or sport game entrance tickets for the sport game's quarter-final, semi-final or final) which is usually rare, highly demanded, valuable, or limited offering in advance at a normal price and resell the specific service at a higher price to make a huge profit. This resale action not only makes the consumers have to pay a higher price to get the specific service, but also make the service providers cannot earn the highest possible profit from the limited service.

Accordingly, an urgent need exists in the art to provide a selling mechanism for preventing the scalper from reselling the limited service and to make the service providers earn the highest possible profit from the limited service.

### SUMMARY OF THE INVENTION

The objective of the present invention is to provide a selling mechanism in which an auction server creates an auction for bidding a limited service during a non-repeatable period, time, and date. By the selling mechanism of the present invention, the price of the limited service (e.g., hotel rooms or ballrooms on New Year's Eve, sport game entrance tickets in the sport game's quarter-final, semi-final or final) may not be hiked by scalpers so that consumers can purchase the limited service at the market equilibrium price. Therefore, the present invention provides an efficient way to prevent the scalpers from reselling the limited service at a higher price and to make the service providers earn the highest possible profit from the limited service.

To achieve the aforesaid objective, the present invention discloses an auction server. The auction server comprises a storage, a network interface and a processor. The network interface is connected to a network. The processor, electrically connected to the storage and the network interface. The processor is configured to create an auction with a bidding period for bidding a limited service during a non-repeatable period, time, and date and receive a plurality of bid requests for the auction from the network via the network interface. Each of the bid requests includes a buyer ID and a bid price. The processor is further configured to store the buyer IDs and the bid prices into the storage and determine at least one winning buyer ID from the buyer IDs according to a quantity of the limited service and the bid prices of the buyer IDs when the bidding period is expired. The bid price of the at least one winning buyer ID is higher than the bid price of the rest of the buyer IDs. The processor generates an auction result indicating the at least one winning buyer ID and the bid price thereof.

In addition, the present invention further discloses a selling method for use in an auction server. The auction server comprises a storage, a network interface, and a processor. The network interface is connected to a network. The processor is electrically connected to the storage and the network interface. The selling method is executed by the processor and comprises the following steps: creating an auction with a bidding period for bidding a limited service during a non-repeatable period, time, and date; receiving a plurality of bid requests for the auction from the network via the network interface, each of the bid requests including a buyer ID and a bid price of the buyer ID; storing the buyer IDs and the bid prices into the storage; determining at least one winning buyer ID from the buyer IDs according to a quantity of the limited service and the bid prices of the buyer IDs when the bidding period is expired; and generating an auction result indicating the at least one winning buyer ID and the bid price thereof. The bid price of the at least one winning buyer ID is higher than the bid price of the rest of the buyer IDs.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating the messages transferring among an auction server 2, a network 11 and user devices 15, 17, 19 in accordance with the first embodiment to the third embodiment of the present invention;

FIG. 2 is a schematic view of the auction server 2 according to the first embodiment to the third embodiment of the present invention; and

FIG. 3 is a flowchart diagram of a selling method according to the fourth embodiment of the present invention.

### DESCRIPTION OF THE PREFERRED EMBODIMENT

The present invention provides an auction server and a selling method thereof. In the following description, the present invention will be explained with reference to embodiments thereof. It shall be appreciated that theses embodiments of the present invention are not intended to limit the present invention to any specific environment, applications or implementations described in these embodiments. Therefore, the description of these embodiments is only for purpose of illustration rather than to limit the present invention and the scope claimed in this application shall be governed by the claims. Additionally, in the following embodiments and the attached drawings, elements unrelated to the present invention are omitted from depiction; and dimensional relationships among individual elements in the attached drawings are illustrated only for ease of understanding, but not to limit the actual scale.

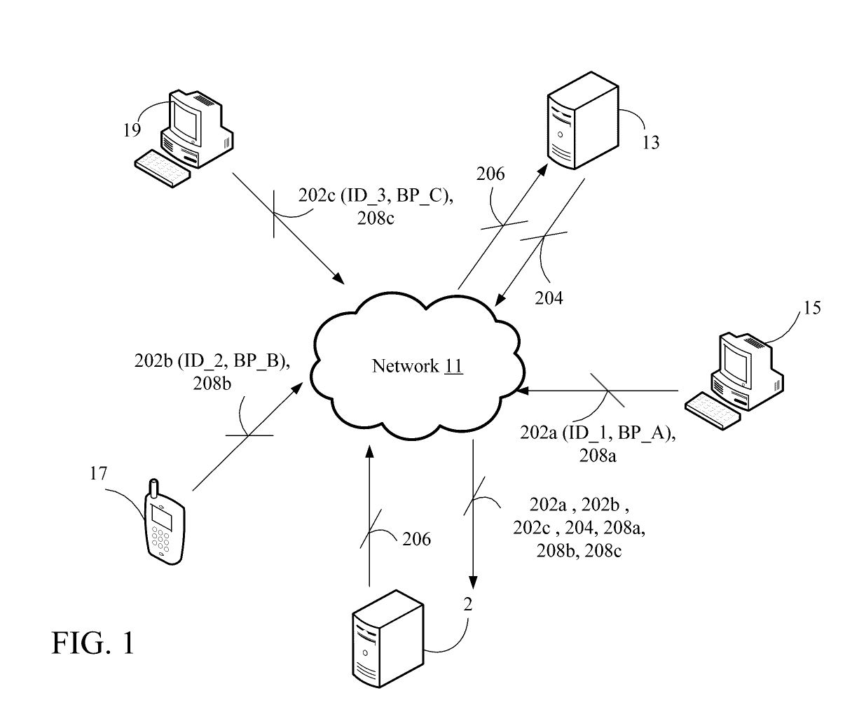

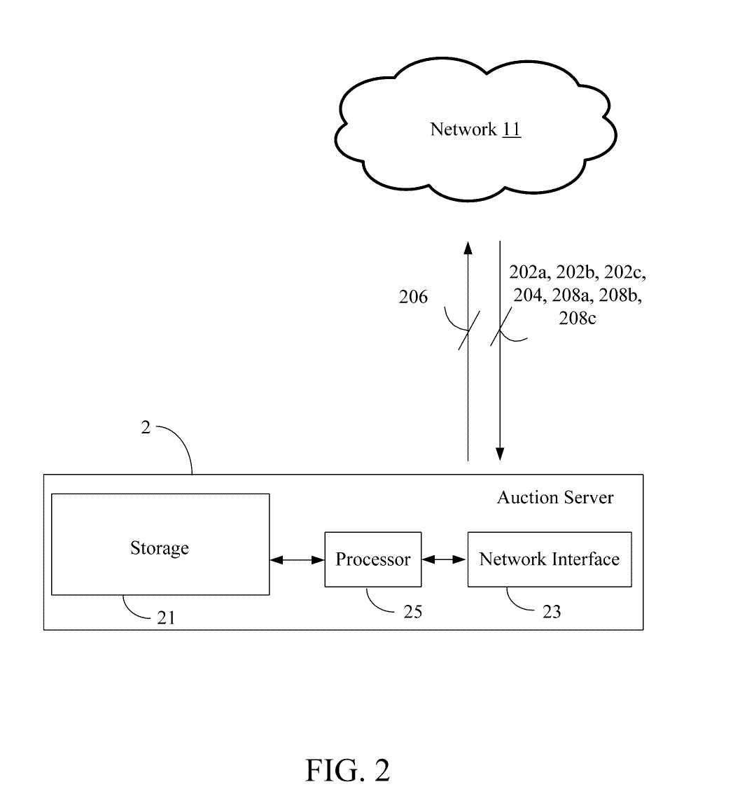

The first embodiment of the present invention is depicted in FIGS. 1-2. FIG. 1 is a schematic diagram illustrating messages transferring among the auction server 2, the network 11 and the user devices 15, 17, 19. FIG. 2 is a schematic diagram of the auction server 2 of the present invention. As shown in FIG. 1, the auction server 2 provides a commercial transaction platform for selling services via the network 11. The auction server 2 may be managed by the service-provider itself or a third party which offers the commercial transaction platform to the service-provider.

Each of the user devices 15, 17, 19 can be a personal computer, a smartphone, a notebook, a table computer or any user device which is capable of communicate with the auction server 2 via the network 11 for bidding a limited service provided from the service-provider. In this embodiment, the user device 15 is a person computer, the user device 17 is a smartphone, and the user device 19 is also a personal computer.

In detail, as shown in FIG. 2, the auction server 2 of the present invention comprises a storage 21, a network interface 23, and a processor 25. The storage 21 may be a tangible machine-readable medium or a combination of multiple tangible machine-readable medium for providing the auction server 2 with a permanent storage, such as a flash memory, a hard disk, or any other storage media with the same function and well known to those skilled in the art. The network interface 23 is connected to a network 11. The processor 25 is electrically connected to the storage 21 and the network interface 23, and configured to execute the operations as described below.

First, the processor 25 creates an auction with a bidding period for bidding a limited service during a non-repeatable period, time, and date. Specifically, the auction may be created based on the data inputted by an operator of the auction server 2 or the data transmitted from a service-providing device 13 of the service-provider. After creating the auction, the processor 25 may receive a plurality of bid requests 202a, 202b, 202c for the auction from the network 11 via the network interface 23. As illustrated in FIG. 1, a buyer A may operates the user device 15 to access the auction server 2 to bid the limited service and transmit the bid request 202a to the auction server 2.

For example, the auction server 2 may be accessed through a website or an application program designed for accessing the auction server 2. Likewise, a buyer B may use the user device 17 to transmit the bid request 202b to the auction server 2, and a buyer C may use the user device 19 to transmit the bid request 202c to the auction server 2. Each of the bid requests 202a, 202b, 202c includes a buyer ID (i.e., ID_1, ID_2 or ID_3) and a bid price (i.e., BP_A, BP_B or BP_C) of the buyer ID.

After receiving the plurality of bid requests 202a, 202b, 202c, the processor 25 further stores the buyer IDs (i.e., ID_1, ID_2, ID_3) and the bid prices (i.e., BP_A, BP_B, BP_C) into the storage 21, and determines at least one winning buyer ID from the buyer IDs according to a quantity of the limited service and the bid prices of the buyer IDs when the bidding period is expired. In other words, according to the quantity of the limited service offered by the service-provider, the processor 25 selects a number of buyer IDs whose bid prices are higher than the rest of the buyer IDs as the winning buyer IDs. That is, the bid price of the at least one winning buyer ID is higher than the bid price of the rest of the buyer IDs. Afterwards, the processor 25 generates an auction result indicating the at least one winning buyer ID and the bid price thereof.

For example, the quantity of the limited service offered by the service-provider is only two pieces. In this case, if the bid price BP_A is highest, the bid price BP_C is lowest among the bid prices BP_A, BP_B, BP_C and each of the buyers A, B C bids one piece of the limited service, the processor 25 would select the buyer ID_1 (i.e., the buyer A) corresponding to the bid price BP_A and the buyer ID_2 (i.e., the buyer B) corresponding to the bid price BP_B as the winning buyer IDs. In other words, since the quantity of the limited service is two pieces, the processor 25 selects the buyer ID_1 and the buyer ID_2 whose bid prices are higher than that of the buyer ID_3 as the winning IDs. Then, the processor 25 generates the auction result that indicates the buyer ID_1 and the buyer ID_2 won the auction with bid price BP_A and bid price BP_B.

More specifically, the auction server 2 of the present invention provides a selling platform for the service-provider. When the limited service (e.g., transportation tickets, game tickets, hotel rooms, ballrooms, etc.) offered by the service-provider is held during a special period, time or seasons (e.g., a holiday season, a graduation season, New Year's Eve, a semi-final or final of a sport game), the service-provider may sell the limited service by the bidding system implemented on the auction server 2 so as to prevent scalpers from reselling the limited service at a higher price, and the service-provider may earn the highest possible profit from the limited service.

On the other hand, it shall be understood that the bid price of each bid request may be restricted. For example, the bid price of each bid request should be higher than the bid price of the provisional winning buyer ID of the buyer IDs (i.e. the current highest bid price), or higher than an initial bid price if the auction server 2 has not received any bid request for this auction. Specifically, the buyer may input a bid price and send a bid request through the website or the application program. In this situation, the website or the application program may be designed to be capable of determining whether the input bid price is higher than the current highest bid price or the initial bid price. In this way, the bid request can be generated only when the input bid price is higher than the current highest bid price or the initial bid price. In other words, the buyer must input a bid price higher than the current highest bid price or the initial price so that the bid request could be generated and transmitted successfully.

In other embodiments, the bid price of each bid request may be determined by the processor 25. In this case, only the bid request with a bid price higher than the current highest bid price or the initial bid price can be accepted by the auction server 2; otherwise, the auction server 2 reply a failure message indicating that the bid price is unacceptable to the buyer. As a result, the current highest bid price would be replaced (updated) with the bid price carrying in the newly received and accepted bid request.

Taking the auction for two pieces of the specific service as an example, the processor 25 may receive the bid requests 202a from the user device 15 at first. The bid price BP_A included in the bid request 202a must be higher than the initial bid price so as to be accepted by the auction server 2. Afterwards, the processor 25 further receives the bid request 202b from the user device 17, and the bid price BP_B included in the bid request 202b must be higher than the bid price BP_A. And, the current highest bid price is changed from the bid price BP_A to the bid price BP_B. Next, the processor 25 further receives the bid request 202c, and the bid price BP_C included in the bid request 202c must be higher than the bid price BP_A and the bid price BP_B, especially the bid price BP_B. Accordingly, the current highest bid price is changed from the bid price BP_B to the bid price BP_C.

As aforementioned, the service-provider may use the service-providing device 13 connected to the network 11 to access the auction server 2 for selling a limited service. In this case, the processor 25 receives an auction service request 204 from the service-providing device 13, and then creates the auction according to the data carrying in the auction service request 204 accordingly. It shall be appreciated that, the service-providing device 13 may be a server, a personal computer, a mobile device or any other devices capable of connecting to the network 11 to access the auction server 2.

In addition, after the bidding period of the auction is expired, the processor 25 further transmits the auction result 206 to the service-providing device 13 which provides the limited service so as to inform the service-provider of the auction result 206. In other embodiments, the processor 25 may also transmit the auction result 206 to the user devices corresponding to the buyer IDs. For example, the auction result 206 may be transmitted through a short message service (SMS), an e-mail, or any instant message. Since those of ordinary skill in the art can easily understand how to transmit the action result to the buyers in various ways, this will not be further described herein. In other example implementations, the auction result 206 may be sent to the user devices directly such that the buyers can get information of the auction result from the web site or the application program.

Please also refer to FIGS. 1-2 for the second embodiment of the present invention, which is an extension of the first embodiment. In this embodiment, each buyer may be required to provide a security deposit in advance to bid the limited service. Therefore, the buyers A, B and C should provide their payment information of the security deposit (for example, respectively utilize their user devices 15, 17, 19 to input the payment information) for joining this auction. The payment information of the security deposit and the corresponding buyer IDs may be included in a plurality of joining requests 208a, 208b, 208c, and transmitted from the user devices 15, 17, 19 to the auction server 2, respectively. In this case, the processor 25 further receives the joining requests 208a, 208b, 208c for the auction from the network 11 via the network interface 23, and each of the joining requests 208a, 208b, 208c includes one of the buyer IDs and the corresponding payment information of the security deposit.

It shall be noted that, in the previously described embodiment, the auction server 2 receives bid requests and the join requests which generated by the user devices. However, in other embodiments, the auction server 2 may also have an interactive voice response system (IVSS) which allows the buyer to input a bid price and/or payment information via the phone so as to generate the bid request and the join request. In other words, the network 11 of the present invention is not limited to the computer network only, instead it may further include the telephone network or any telecommunications network, and the scope of present invention is not limited to how the bid request is generated. Those of skilled in the art can easily understand how to realize various implementations on the generation of the bid request based on the above description, and thus, will not be further described herein.

The third embodiment of the present invention is also an extension of the first or second embodiment. In this embodiment, various implementations of the present invention will be described. As aforementioned, the service-provider utilizes the auction server 2 of the present invention to sell the limited service during a special period, time, or date in order to prevent scalpers from reselling the limited service. In the present invention, the limited service may be any of the items listed as follows:
i. the limited service is selected from the group consisting of a permit, a right and a ticket for admitting into an area (e.g., a sport center, a sport field, or a sport stadium) in which a sport game in a quarter-final, a semi-final or a final is held.
ii. the limited service is selected from the group consisting of a permit, a right and a ticket for admitting into an area (e.g., a concert hall, a park, a building) in which a concert for a festival is held.
iii. the limited service is selected from the group consisting of a transportation ticket, a transportation permit and a transportation right for travelling during a holiday season.
iv. the limited service is a hotel room or a ballroom in a hotel for accommodation during a commencement week of a college or a university, and the hotel is located within a radius distance of 50 miles to the college or the university.
v. the limited service is a hotel room or a ballroom in a hotel for accommodation during a holiday season, and the hotel is located within a radius distance of 20 miles to a landmark.
vi. the limited service is a hotel room or a ballroom in a hotel for accommodation ten days before and after New Year's Eve and including New Year's Eve, and the hotel is located within a radius distance of 20 miles to a landmark.
vii. the limited service is a hotel room or a ballroom in a hotel for accommodation during a quarter-final, a semi-final or a final of a sport game, and the hotel is located within a radius distance of 50 miles to an area (e.g., sport center, or a sport field, or a sport stadium) in which the sport game is held.
viii. the limited service is a hotel room or a ballroom in a hotel for accommodation ten days before and after a concert and including the performance day of the concert, and the hotel is located within a radius distance of 50 miles to an area (e.g., a concert hall, a park or a building) in which the concert is held.

In other words, the auction created by the processor 25 of the present invention is to sell the entrance tickets, rights or permits of a quarter-final, semi-final or final sport game or a concert for a festival, the transportation tickets, permits or rights in a holiday season, the hotel rooms or the ballrooms in the hotel nearby a landmark in a holiday season or on New Year's Eve, the hotel rooms or ballrooms nearby a university in a graduation season (e.g., during the commencement week), or the like.

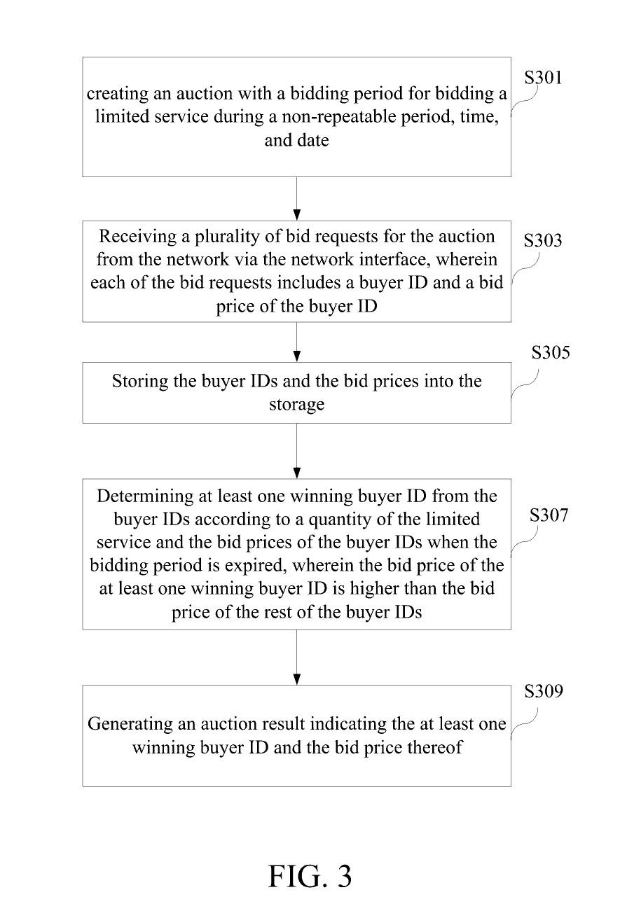

The fourth embodiment of the present invention is a selling method, a flow chart of which is shown in FIG. 3. The selling method is for use in an auction server, e.g., the auction server 2 of the first to third embodiments. The auction server comprises a storage, a network interface, and a processor. The network interface is connected to a network. The processor is electrically connected to the storage and the network interface, and the selling method is executed by the processor.

First, step S301 is executed to create an auction with a bidding period for bidding a limited service during a non-repeatable period, time, and date. Then, step S303 is executed to receive a plurality of bid requests for the auction from the network via the network interface. In detail, each of the bid requests includes a buyer ID and a bid price of the buyer ID. Next, step S305 is executed to store the buyer IDs and the bid prices into the storage. Afterwards, step S307 is executed to determine at least one winning buyer ID from the buyer IDs according to a quantity of the limited service and the bid prices of the buyer IDs when the bidding period is expired. It shall be appreciated that the bid price of the at least one winning buyer ID is higher than the bid price of the rest of the buyer IDs. Finally, step S309 is executed to generate an auction result indicating the at least one winning buyer ID and the bid price thereof.

As previously described, in an implementation, the limited service may be a permit, right, or ticket for admitting into an area in which a sport game in a quarter-final, a semi-final or a final is held. In another implementation, the limited service is a permit, right, or ticket for admitting into an area in which a concert for a festival or for a popular performer whose tickets have always been sold out within few hours after public sales is held. In another implementation, the limited service is a transportation ticket, transportation permit, or transportation right for travelling during a holiday season.

In addition, the limited service may be a hotel room or a ballroom offered during a special period. In an implementation, the limited service may be a hotel room or a ballroom in a hotel for accommodation during a college or a university's commencement week, and the hotel is located within a radius distance of 50 miles to the school (i.e., the college or the university). And, in another implementation, the limited service may be a hotel room or a ballroom in a hotel for accommodation during a holiday season, and the hotel is located within a radius distance of 20 miles to a landmark. In another implementation, the limited service may be a hotel room or a ballroom in a hotel for accommodation ten days before and after New Year's Eve and including New Year's Eve, and the hotel is located within a radius distance of 20 miles to a landmark. In another implementation, the limited service is a hotel room or a ballroom in a hotel for accommodation during a sport game's quarter-final, semi-final or final, and the hotel is located within a radius distance of 50 miles to an area in which the sport game is held. Moreover, in another implementation, the limited service may be a hotel room or a ballroom in a hotel for accommodation ten days before and after a concert and including the concert's performance day, and the hotel is located within a radius distance of 50 miles to an area in which the concert is held.

In other embodiments, after the bidding period is expired and the auction result is determined (i.e., after S309 as shown in FIG. 3), the selling method of the present invention further comprises the following step: transmitting the auction result to a service-providing device which provides the limited service. Besides, in other embodiments, the selling method further comprises the following steps of receiving an auction service request from the service-providing device and creating the auction according to the auction service request.

Moreover, in other embodiments, the selling method further comprises the following step of receiving a plurality of joining requests for the auction from the network via the network interface. In detail, each of the joining requests includes one of the buyer IDs and payment information for a security deposit. In another embodiment, the bid price of each of the bid requests is higher than the bid price of the provisional winning buyer ID of the buyer IDs.

In addition to the aforesaid steps, the selling method of the present invention can also execute all the operations and corresponding functions set forth in the first to third embodiments. How to execute these operations and functions will be readily appreciated by those of ordinary skill in the art based on the explanation of the first to third embodiments, and thus, will not be further described herein.

According to the above descriptions, the auction server and the selling method of the present invention provide a commercial transaction platform for the service-providers to sell the limited service during a non-repeatable period, time, and date. Accordingly, the present invention provides an efficient way to prevent the scalpers from reselling the limited service at a higher price and to make the service providers earn the highest possible profit from the limited service.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An auction server, comprising:
a storage;
a network interface, connected to a network; and
a processor, electrically connected to the storage and the network interface, being configured to execute the following operations:
creating an auction with a bidding period for bidding a limited service during a non-repeatable period, time, and date;
receiving a plurality of bid requests for the auction from the network via the network interface, wherein each of the bid requests includes a buyer ID and a bid price of the buyer ID;
storing the buyer IDs and the bid prices into the storage;
determining at least one winning buyer ID from the buyer IDs according to a quantity of the limited service and the bid prices of the buyer IDs when the bidding period is expired, wherein the bid price of the at least one winning buyer ID is higher than the bid price of the rest of the buyer IDs; and
generating an auction result indicating the at least one winning buyer ID and the bid price thereof.

2. The auction server of claim 1, wherein the limited service is selected from the group consisting of a permit, a right and a ticket for admitting into an area in which a sport game in a quarter-final, a semi-final or a final is held.

3. The auction server of claim 1, wherein the limited service is selected from the group consisting of a permit, a right and a ticket for admitting into an area in which a concert for a festival is held.

4. The auction server of claim 1, wherein the limited service is selected from the group consisting of a transportation ticket, a transportation permit and a transportation right for travelling during a holiday season.

5. The auction server of claim 1, wherein the limited service is a hotel room or a ballroom in a hotel for accommodation during a commencement week of a college or a university, and the hotel is located within a radius distance of 50 miles to the college or the university.

6. The auction server of claim 1, wherein the limited service is a hotel room or a ballroom in a hotel for accommodation during a holiday season, and the hotel is located within a radius distance of 20 miles to a landmark.

7. The auction server of claim 1, wherein the limited service is a hotel room or a ballroom in a hotel for accommodation ten days before and after New Year's Eve and including New Year's Eve, and the hotel is located within a radius distance of 20 miles to a landmark.

8. The auction server of claim 1, wherein the limited service is a hotel room or a ballroom in a hotel for accommodation during a quarter-final, a semi-final or a final of a sport game, and the hotel is located within a radius distance of 50 miles to an area in which the sport game is held.

9. The auction server of claim 1, wherein the limited service is a hotel room or a ballroom in a hotel for accommodation ten days before and after a concert and including the performance day of the concert, and the hotel is located within a radius distance of 50 miles to an area in which the concert is held.

10. The auction server of claim 1, wherein the processor further executes the following operation:
transmitting the auction result to a service-providing device which provides the limited service.

11. The auction server of claim 10, wherein the processor further executes the following operations:
receiving an auction service request from the service-providing device; and
creating the auction according to the auction service request.

12. The auction server of claim 1, wherein the processor further executes the following operation:
receiving a plurality of joining requests for the auction from the network via the network interface, wherein each of the joining requests includes one of the buyer IDs and payment information of a security deposit.

13. The auction server of claim 1, wherein the bid price of each of the bid requests is higher than the bid price of a provisional winning buyer ID of the buyer IDs.

14. A selling method for use in an auction server, the auction server comprising a storage, a network interface, and a processor, the network interface being connected to a network, the processor being electrically connected to the storage and the network interface, the selling method being executed by the processor and comprising the following steps:
creating an auction with a bidding period for bidding a limited service during a non-repeatable period, time, and date;
receiving a plurality of bid requests for the auction from the network via the network interface, wherein each of the bid requests includes a buyer ID and a bid price of the buyer ID;
storing the buyer IDs and the bid prices into the storage;
determining at least one winning buyer ID from the buyer IDs according to a quantity of the limited service and the bid prices of the buyer IDs when the bidding period is expired, wherein the bid price of the at least one winning buyer ID is higher than the bid price of the rest of the buyer IDs; and
generating an auction result indicating the at least one winning buyer ID and the bid price thereof.

15. The selling method of claim 14, wherein the limited service is selected from the group consisting of a permit, a right and a ticket for admitting into an area in which a sport game in a quarter-final, a semi-final or a final is held.

16. The selling method of claim 14, wherein the limited service is selected from the group consisting of a permit, a right and a ticket for admitting into an area in which a concert for a festival is held.

17. The selling method of claim 14, wherein the limited service is selected from the group consisting of a transportation ticket, a transportation permit and a transportation right for travelling during a holiday season.

18. The selling method of claim 14, wherein the limited service is a hotel room or a ball room in a hotel for accommodation during a commencement week of a college or a university, and the hotel is located within a radius distance of 50 miles to the college or the university.

19. The selling method of claim 14, wherein the limited service is a hotel room or a ball room in a hotel for accommodation during a holiday season, and the hotel is located within a radius distance of 20 miles to a landmark.

20. The selling method of claim 14, wherein the limited service is a hotel room or a ball room in a hotel for accommodation ten days before and after New Year's Eve and including New Year's Eve, and the hotel is located within a radius distance of 20 miles to a landmark.

21. The selling method of claim 14, wherein the limited service is a hotel room or a ball room in a hotel for accommodation during a quarter-final, a semi-final or a final of a sport game, and the hotel is located within a radius distance of 50 miles to an area in which the sport game is held.

22. The selling method of claim 14, wherein the limited service is a hotel room or a ball room in a hotel for accommodation ten days before and after a concert and including the performance day of the concert, and the hotel is located within a radius distance of 50 miles to an area in which the concert is held.

23. The selling method of claim 14, further comprising the following step:
transmitting the auction result to a service-providing device which provides the limited service.

24. The selling method of claim 23, further comprising the following steps:
receiving an auction service request from the service-providing device; and
creating the auction according to the auction service request.

25. The selling method of claim 14, further comprising the following step:
receiving a plurality of joining requests for the auction from the network via the network interface, wherein each of the joining requests includes one of the buyer IDs and payment information for a security deposit.

26. The selling method of claim 14, wherein the bid price of each of the bid requests is higher than the bid price of a provisional winning buyer ID of the buyer IDs.
